(19) United States
(12) Patent Application Publication
(10) Pub. No.: US 2015/0081490 A1
(43) Pub. Date: Mar. 19, 2015

(54) SYSTEMS AND METHODS FOR CONVERTIBLE PREPAID ACCOUNT

(71) Applicant: SYNCHOLOGY LLC, Chicago, IL (US)

(72) Inventors: Douglas Ray Bobenhouse, Chicago, IL (US); Lisa Ann Doppenberg, Sioux Falls, SD (US); Thomas Lee Kracht, Sioux Falls, SD (US)

(73) Assignee: SYNCHOLOGY LLC, Chicago, IL (US)

(21) Appl. No.: 14/026,978

(22) Filed: Sep. 13, 2013

(51) Int. Cl. G06Q 40/02

(52) U.S. Cl. CPC G06Q 40/02
USPC 705/35

(57) ABSTRACT

Systems and methods are providing for managing and promoting a prepaid account. According to one aspect, a request to create a non-user-funded prepaid account for a user is received, the request including information about the user and an amount of money to be deposited into the non-user-funded account. The user information is provided to an account processing entity to establish the non-user-funded prepaid account, and the account processing entity provides account information for the non-user-funded account. The account information is provided to the user, along with an offer to convert the non-user-funded prepaid account to a user-fundable prepaid account. Upon receiving a selection of the option to convert, a conversion of the non-user-funded prepaid account to a user-fundable prepaid account may be arranged by, for example, changing a first product id associated with the non-user-funded account to a second product id defining a user-funded prepaid account.

### FIELD

This application generally relates to systems and methods for operating and marketing prepaid cards and accounts. In particular, the application relates to platforms and techniques for operating and/or marketing prepaid accounts having a component for converting a non-user-funded prepaid account to a user-fundable reloadable prepaid account.

### BACKGROUND

Prepaid card accounts, whether virtual (e.g., electronic) or physical (e.g., plastic), have become popular for a number of reasons. One, conventional prepaid cards are functionally useful like debit cards in that the funds are automatically deducted from the cardholder's account. This eliminates the need for repayment by the cardholder and avoids the risk of loss or the burden of finance charges. Second, prepaid cards need not be linked to a demand deposit account at a bank. This may be desirable for consumers that would like the functionality of a debit purchase without an account at a bank. Third, prepaid cards can provide an anonymity that is not available with credit or debit cards. For example, with some prepaid cards, the identity of the card holder need not be verified at all when making a purchase or setting up the card. As another example, many prepaid cards are not issued in the name of any particular person. A fourth advantage of conventional prepaid cards is that they can be used to buy goods and services almost immediately after the card is purchased or an amount is loaded or reloaded.

Conventional prepaid cards can come with a variety of different features, restrictions, and conditions. Some prepaid cards can be purchased by a consumer for a predetermined amount of money that is preloaded onto the card (e.g., $25, $50, $100). Other prepaid cards come with a zero balance and the purchaser is able to add or load money onto the card. Data indicating a cash value of the prepaid card can be stored directly on the card, for example, in a memory chip included in the card or in a remote location (e.g., at a host computer) that can be accessed using information stored on an integrated circuit or magnetic strip included on the card. When the prepaid card is used to make a purchase, the data indicating the cash value of the prepaid card is updated to reflect the decrease in cash value.

Conventional prepaid cards can also differ in terms of where they may be used to buy goods and services. Some prepaid cards have a closed system account that is issued by a particular merchant and may only be used at that merchant (e.g., store gift cards). There are also prepaid cards that are considered “semi-closed” because they are issued by a third party and may be used at multiple merchants (e.g., mall gift cards). Other prepaid cards have an open system account that may be linked to a payment network, such as VISA® or MasterCard®, and may be used to make purchases at any merchant that accepts or is affiliated with the payment network (e.g., similar to a debit or credit card). Additionally, conventional prepaid cards differ with regard to what occurs once the initial balance is depleted. Some prepaid cards are “reloadable,” such that the card holder may load and reload funds onto the card. Other prepaid cards are “single use” cards that expire once the initial balance is completely depleted.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 illustrates a system in accordance with one embodiment of the invention;

FIG. 2 illustrates one form of a computer or server in FIG. 1 for implementing one embodiment of the invention;

FIG. 3 illustrates a flowchart including operations that may be implemented using the system of FIG. 1.

FIG. 4 illustrates a flowchart including operations that may be implemented using the system of FIG. 1.

FIG. 5 illustrates a flowchart showing the flow of money according to one embodiment.

FIG. 6 illustrates a flowchart showing the flow of information in the system of FIG. 1.

### DETAILED DESCRIPTION

Systems and methods are described herein for converting a non-user-funded prepaid account (e.g., a corporate-funded cash card) into a user-fundable prepaid account (e.g., a general purpose reloadable prepaid card). The two types of accounts may be collectively referred to herein as “a convertible prepaid account.” As used herein, the term “prepaid account” refers to any type of account that is associated with a preloaded cash value and may be used to make electronic payments for goods and services using that cash value. In some instances, the prepaid account may be considered to be a debit account. The term “prepaid account” may also include the term “prepaid card” as it is generally known in the industry and by those skilled in the art. In some embodiments, the convertible prepaid account may be associated with an account transaction mechanism or device, such as a physical (plastic) prepaid card, a virtual prepaid card, and/or a mobile payment device, as explained in more detail below.

According to one aspect, the non-user-funded prepaid account may be an open, closed, or semi-closed system account that is funded by an entity other than the ultimate cardholder or user. For example, the user may have won a $100 raffle prize in a contest sponsored by a corporation. Rather than awarding cash, the corporation may choose to provide a $100 prepaid card to the user. In one embodiment, the prepaid card may have the corporation's brand or logo printed on the card. In another embodiment, the prepaid card may also be associated with a rewards or points system that is affiliated with the corporation. In either case, the prepaid card continues to promote the brand of the corporation, whether directly or indirectly, but only for as long as the user keeps using the card. In some instances, such prepaid cards may not be user-reloadable (e.g., only the corporation may reload funds onto the card). Thus, these cards may expire once the cash value is depleted, or zero, which also ending the promotion of the corporation's brand.

The systems and methods disclosed herein arrange a conversion of the transitory, non-user-funded prepaid account into a long(er)-term, user-fundable prepaid account that can continue to endorse or promote the initial funding entity even after expending the initial promotional value. According to one aspect, the user-fundable prepaid account may be an open system or general purpose reloadable account that can be funded by the user, or a user-authorized entity (e.g., an employer authorized to provide direct deposits). In a preferred embodiment, the convertible prepaid account may be an open system account before and/or after conversion, so that the account holder can use the funds at any merchant location that is affiliated with the payment network associated with the account, as described in more detail below.

A prepaid account facilitator may arrange the conversion by providing the non-user-funded prepaid account to the user and offering therewith an option to convert the account to a user-fundable reloadable prepaid account. For example, in the above raffle prize example, the prepaid account facilitator may operate on behalf of the corporation to manage and/or facilitate (i) creation of a $100 corporate-funded prepaid account for the raffle prize winner, (ii) manufacturing of a corresponding corporate-branded $100 prepaid card, (iii) mailing of the card to the raffle prize winner, (iv) provision of promotional materials to the raffle prize winner, offering an option to convert the card to a general purpose reloadable prepaid card, and (v) arranging of the conversion upon receiving acceptance of the offer to convert by the raffle prize winner. In a preferred form of this system, acceptance of the offer involves receiving personal information from the consumer and verifying that information as discussed herein.

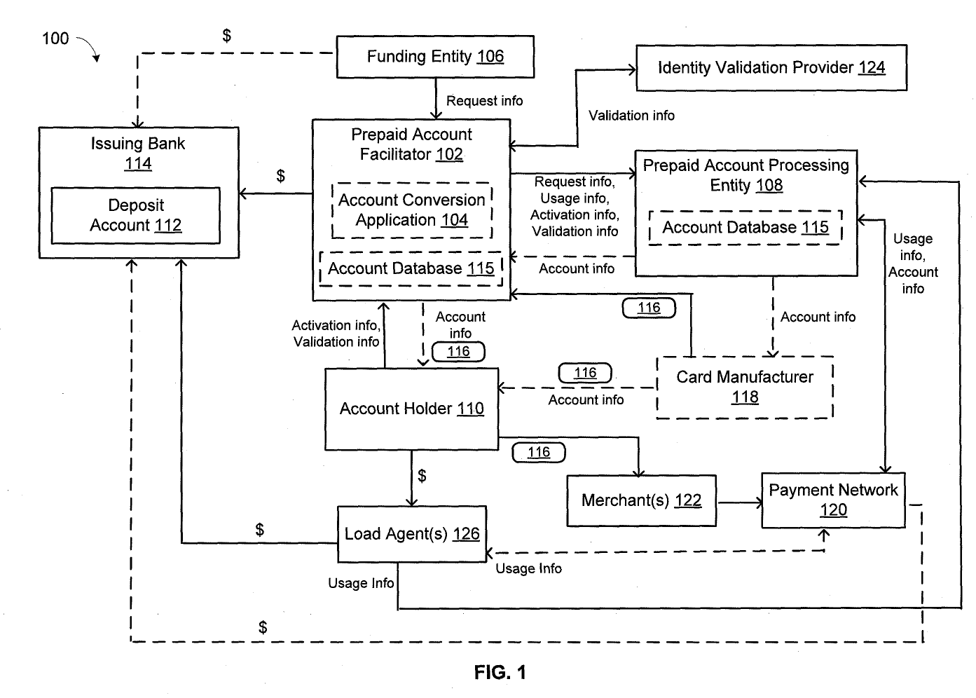

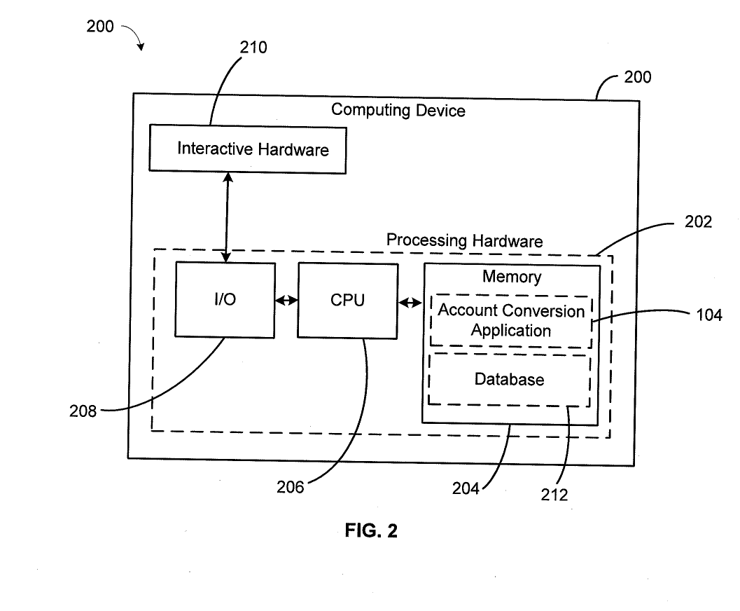

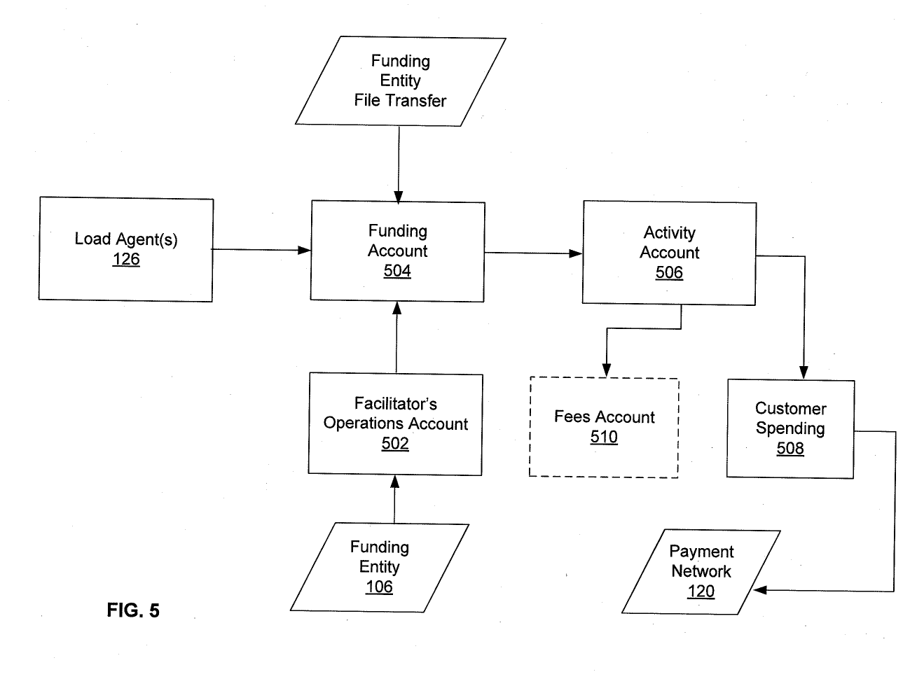

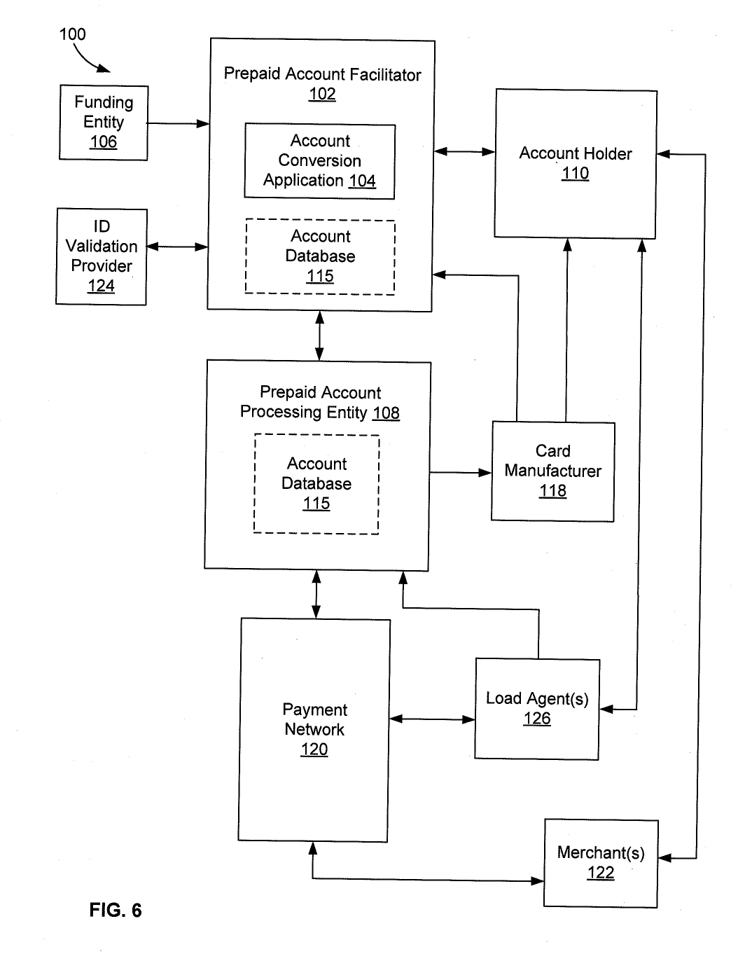

Referring now to FIG. 1, shown is a system diagram illustrating an embodiment of a computer-networked system 100 for arranging a conversion of a non-user-funded prepaid account into a user-fundable prepaid account in accordance with one or more of the principles described herein. The system 100 may include components that are connected through a network, such as the Internet, which can facilitate communications through secure channels. The components of the system 100 may represent entities that arrange, contribute to, or facilitate at least a portion of the creation, processing, usage, and/or conversion of the convertible prepaid account. Various components of the system 100 may own, operate, control, or be otherwise affiliated with one or more computers (e.g., servers, personal computers, computing devices, mobile devices, etc.) that are configured to execute software for implementing the principles disclosed herein. An exemplary computer 200 for executing such software is shown in FIG. 2 and will be discussed in more detail below. Further, one or more of the components illustrated in FIG. 1 may be combined with, incorporated into, owned, operated, or controlled by, and/or affiliated with one or more of the other components included in the system 100. FIG. 6 also illustrates the system 100 but shows only the flow of information between the different components. FIG. 5 illustrates the flow of money between certain components of the system 100 and will be discussed in more detail below.

According to one aspect, the system 100 includes a prepaid account facilitator 102 (hereinafter “facilitator 102”) that is centrally connected to or in communication with each of the other components of the system 100, directly and/or indirectly. In one embodiment, the prepaid account facilitator 102 may own, operate, or otherwise implement a prepaid account conversion software application 104 (hereinafter “account conversion application 104”) in accordance with the principles disclosed herein. The facilitator 102 may represent any type of entity (e.g., a private corporation, a government organization, a non-profit organization, an individual person, etc.) that facilitates, arranges, promotes, and/or otherwise handles a conversion of a non-user-funded prepaid account into a user-fundable prepaid account. According to one aspect, all or portions of the facilitator 102 and/or the account conversion application 104 may be owned, controlled, or operated by, or otherwise affiliated with, one or more of the other components of the system 100.

For example, in some embodiments, the facilitator 102 may promote a convertible prepaid account on behalf of a third-party, such as a funding entity 106, that wishes to distribute such accounts and that supplies an amount of money to be deposited into the account. In one embodiment, the facilitator 102 may be under the control of, contracted by, and/or otherwise affiliated with the funding entity 106. In another embodiment, the facilitator 102 may provide all or portions of the account conversion application 104 to the funding entity 106 for implementation on computer(s) owned or operated by the funding entity 106 or affiliates thereof. According to some aspects, the facilitator 102 may establish convertible prepaid accounts for several different funding entities at a time.

The funding entity 106 may be any type of entity, such as, for example, a private corporation, a government organization, a non-profit organization, an individual person, etc. The funding entity 106 may initiate or sponsor issuance of a prepaid account for a number of reasons, including, for example, to distribute loyalty-based rewards earned by the customer, to dispense rebates for which the customer has submitted qualifying information, to award prizes won in contests sponsored by the funding entity 106, and/or to gain market exposure and encourage customers to buy the funding entity's goods or services. In one example, the funding entity 106 may represent a corporate entity, such as, e.g., a hotel chain, a food chain, a consumer electronics company, or other retail related business. In another example, the funding entity 106 may be an employer of the card holder that, for example, wishes to distribute payment for services rendered (e.g., payroll payments), to reimburse the cardholder for business-related expenses (e.g., per diem, business-related meal expenses, etc.), or provide performance-based incentive bonuses.

Referring back to FIGS. 1 and 6, the facilitator 102 may be in communication with, e.g., exchange information with, a prepaid account processing entity 108 (also referred to herein as “a processing entity 108”). The processing entity 108 may establish, process, and/or arrange prepaid accounts at the request of, or on behalf of, a third party client, such as the facilitator 102 and/or the funding entity 106. The prepaid accounts may be issued to an account holder 110 (also referred to herein as “user 110”) based on the information received from the facilitator 102.

In one exemplary embodiment, the facilitator 102 receives a request to create a new convertible prepaid account from the funding entity 106. According to one aspect, the request may include a minimum amount of information that is required to create the convertible prepaid account. For example, the request may include basic information about the user 110, such as, a name, an address, and/or a telephone number of the user. The request may be generated by the funding entity 106 based on information received directly from the user 110 (e.g., in a contest entry form, a rebate form, etc.) and/or based on information acquired from other sources having the user's information.

Upon receiving the request, the facilitator 102 may submit at least some of the user information to the processing entity 108 to create the convertible prepaid account, or more specifically, the initial non-user-funded prepaid account. The facilitator 102 and/or the processing entity 108 may assign a unique account number to the convertible prepaid account for each user, even if funds are pooled in a pool account. The account number may be used to identify, or link to, the convertible prepaid account when making a purchase, as is conventional. According to some embodiments, the facilitator 102 and/or the processing entity 108 may also assign a consumer number to the convertible prepaid account to identify the account holder 110.

According to some aspects, the request may also include an amount of money to be placed into the convertible prepaid account. According to one aspect, the amount of money included in the request may be transferred from the funding entity 106 to the facilitator 102 and then, ultimately, to an issuing bank 114 using conventional means for setting up prepaid accounts. In one example, the funding entity 106 may electronically transfer or deposit the user's money into a deposit account 112 controlled by the facilitator 102, the deposit account 112 being held at an issuing bank 114. According to one aspect, the deposit account 112 may include a pool of money that is used to fund a plurality of prepaid accounts established by the facilitator 102 for the funding entity 106 and/or for other funding entities. According to other aspects, the money provided by the funding entity 106 may be transferred from the deposit account 112 into one or more other bank accounts held at the same issuing bank 114 and/or held at other banks that are associated with the facilitator 102 and/or with the prepaid accounts created by the facilitator 102, as will be appreciated by those familiar with the field of prepaid accounts.

The system 100 may include an account database 115 for storing account information related to the convertible prepaid accounts that are created and/or processed by the processing entity 108. As illustrated in FIGS. 1 and 6, the account database 115 may be included in, or saved on a computer affiliated with the processing entity 108. In other embodiments, the account database 115 may be stored on a computer affiliated with the facilitator 102. The account information stored in the account database 115 may include any information included in the request to create a new convertible prepaid account, including information about the user and the funds that will be linked to the account. These funds may define an account balance of the convertible prepaid account, and this account balance may be stored in the account database 115 as part of the account information. As another example, the account information stored in the account database 115 may include the account number assigned to each convertible prepaid account. In one preferred embodiment, the account database 115 may be stored on a computer affiliated with or controlled by the processing entity 108, and the processing entity 108 may share the information stored in the account database 115 with the facilitator 102 upon request.

As yet another example, the account information may also include certain features associated with the account and an account category for each account. For example, in some embodiments, each account may belong to an account category based on the parameters, restrictions, terms and conditions, and/or other features that are applicable to the account. An exemplary list of account categories may include open system, closed system, semi-closed system, reloadable, non-reloadable, general-purpose, merchant-specific, non-user-funded, user-fundable, stored-value, etc. According to some aspects, one feature of a non-reloadable prepaid account may be the inability to load additional funds into the account, while one feature of a reloadable prepaid account may be the ability to load additional funds into the account. According to one aspect, a non-reloadable prepaid account may have a different set of terms and conditions with the issuing bank 114 (which is holding the funds associated with the account) than a reloadable system prepaid account. According to one aspect, the set of terms and conditions (or more simply, the set of conditions) may govern, for example, whether the issuing bank 114 is required to satisfy FDIC and Regulation E requirements, issue bank statements, verify an identity of the account holder, and other bank-related matters. In one embodiment, a non-user-funded prepaid account may be associated with a first set of conditions in which, for example, FDIC and Regulation E requirements do not apply, bank statements are not required, and an identity of the account holder need not be verified. And the user-fundable prepaid account may be associated with a second set of conditions in which, for example, FDIC and Regulation E requirements do apply, bank statements are required, and an identity of the account holder must be verified.

According to one aspect, each account category may be assigned a product identification code or “product id” (e.g., non-reloadable=product id 1, reloadable=product id 2, etc.). Moreover, according to some embodiments, conversion of a prepaid account from non-user-funded to user-fundable may be carried out by changing the product id associated with the account. For example, in one embodiment, the non-user-funded prepaid account, which is associated with the first set of conditions, may be assigned a first product id, and the user-fundable prepaid account, which is associated with the second set of conditions, may be assigned a second product id. According to one aspect, the facilitator 102 defines the parameters and conditions that are associated with each product id. As a result, the facilitator 102 can decide which account type will be associated with the pre-conversion state of the convertible prepaid account and which account type will be associated with the post-conversion state of the account. For example, the facilitator 102 may configure the product ids so that the pre-conversion account is an open system, non-user-funded, reloadable prepaid account (e.g., entities other than the user, such as the funding entity, can load funds into the account) and the post-conversion account is an open system, user-fundable, reloadable prepaid account(e.g., the user can load funds onto the account). The facilitator 102 may provide the definitions selected for each product id to the account database 115 for storage therein.

Upon determining that the account holder wishes to convert the prepaid account from a non-user-funded account to a user-fundable account, the facilitator 102 may instruct the processing entity 108 to change the product id of the non-user-funded prepaid account from the first product id to the second product id, thereby changing the account to a user-fundable prepaid account. The new product id, and account category associated therewith, may be stored in the account database 115 in association with an entry for the convertible prepaid account. In a preferred embodiment, the step of receiving notification that the user wishes to convert the account to a user-fundable account includes the receipt of personal information from the user which may then be verified, and such verification serves as an approval process for establishing the user-fundable account and thereby, is a qualifying step prior to changing the account to a user-fundable account, as discussed below in more detail.

According to one aspect, the convertible prepaid account may be associated with an account transaction mechanism 116. In some embodiments, the account transaction mechanism 116 is a physical (typically plastic) prepaid card, cash card, promotional value card, gift card, or any other type of stored-value card that, for example, can be used to make in-person purchases at merchant locations and/or online purchases at merchant websites. As shown in FIG. 1, the processing entity 108 may be in communication with a card manufacturer 118 that prints or manufactures physical prepaid cards using account information provided by the processing entity 108. For example, the account information may include a name of the account holder 110, and the prepaid card may have the name of the account holder 110 printed thereon. In one embodiment, the account information may include an account number associated with the prepaid card, and the prepaid card may have the account number printed thereon. Other information may also be printed on the prepaid card, such as a customer number, a verification number, a name of the issuing bank 114, a logo of the funding entity 108, etc.

According to other embodiments, the account transaction mechanism 116 may be an electronic prepaid account (e.g., a virtual prepaid “card”) that consists of the account number associated with the account and that can be used to buy goods or services at merchant locations where an account number is sufficient to make a purchase (e.g., a physical card need not be presented). For example, the virtual prepaid card 116 could be used to make online purchases and payments. In one embodiment, the virtual prepaid card 116 may include a mobile payment device that can be stored on an electronic device and can be used to make purchases via the electronic device. For example, the mobile payment device 116 may be included in a mobile wallet that is stored on a mobile computing device (e.g., a smartphone, a cellular telephone, a tablet computer, a laptop computer, etc.) according to conventional means.

In some embodiments, the convertible prepaid account may be associated with a single account transaction mechanism 116 through conversion from a non-user-funded account to a user-fundable account. For example, a physical prepaid card may be associated with the non-user-funded account, and after conversion of the account, the same prepaid card may be associated with the new user-fundable account. In other embodiments, the convertible prepaid account may be associated with different account transaction mechanisms before and after conversion. For example, the convertible prepaid account may be associated with a virtual prepaid card while the account is a non-user-funded account. Once the account is converted to a user-fundable account, the account may be associated with a physical prepaid card. In one embodiment, the virtual prepaid card may be replaced by the physical prepaid card after conversion. In another embodiment, the virtual prepaid card may be upgraded to, or enhanced by the addition of, the physical card, and both of the account transaction mechanisms may be associated with the user-fundable account. In another example, the reverse may be true: the non-user-funded account may be associated with a physical prepaid card and the user-fundable account may be associated with a virtual prepaid card in addition to, or instead of, the physical card. As will be appreciated, the convertible prepaid account may be associated with any combination of account transaction mechanisms before and after conversion in accordance with the principles disclosed herein.

In a preferred embodiment, the convertible prepaid account is associated or affiliated with a payment network 120 (e.g., VISA, MasterCard, American Express, etc.). This provides the prepaid account with more flexibility and usability by allowing the account to be used at any merchant that is affiliated with, or accepts payment through, the given payment network 120. In one embodiment, the processing entity 108 may communicate with a given payment network 120 to arrange an affiliation therewith using conventionally available methods. In another embodiment, the funding entity 106 may specify, in the request sent to the facilitator 102, with which payment network the account should be affiliated. In yet another embodiment, the facilitator 102 and/or the processing entity 108 may have a predetermined relationship with a specific payment network 120 and may choose to affiliate all convertible prepaid accounts with this network 120. The name of the payment network 120 affiliated with each prepaid account may be stored in the account database 115, along with the other account information. In some embodiments, the logo of the affiliated payment network 120 may be displayed, or printed, on a physical prepaid card.

Once the convertible prepaid account is created, the facilitator 102 may arrange for delivery of the new account information to the account holder 110. According to one aspect, the facilitator 102 may request the card manufacturer 118 to handle distribution of the account transaction mechanism 116 to the account holder 110. For example, in embodiments where the account transaction mechanism 116 is a physical prepaid card, the card manufacturer 118 may mail the printed card 116 directly to the account holder 110. According to another aspect, the facilitator 102 may directly handle distribution of the account transaction mechanism 116. For example, in embodiments where the account transaction mechanism 116 is a physical prepaid card, the card manufacturer 118 may provide the printed card 116 to the processing entity 108, and the processing entity 108 may provide the card 116 to the facilitator 102 for distribution to the account holder 110. As another example, in embodiments where the account transaction mechanism 116 is a virtual prepaid card or a mobile payment device, the processing entity 108 may provide the necessary account information to the facilitator 102 after creating the convertible prepaid account, and the facilitator 102 may electronically transfer (e.g., email, text message, file transfer, etc.) the account transaction mechanism 116 to a computing device associated with the account holder 110 for download onto and/or display on the computing device. In either regard, the user is provided an account transaction mechanism 116 (e.g., a card or virtual account, etc.) as the new account information is provided to the account holder 110.

According to some aspects, almost immediately upon receiving the account transaction mechanism 116 and/or the account information for the convertible prepaid account, the account holder 110 may be able to begin using the account transaction mechanism 116 to make purchases at one or more merchants 122. In one embodiment, usage of the convertible prepaid account signifies activation of the account and automatic acceptance of conditions associated with the account, such as the first set of conditions that are associated with the non-user-funded prepaid account. According to one aspect, the processing entity 108 may receive notification of account usage from, for example, the merchant 122, and may notify the facilitator 102 of the account activation and thereby, the acceptance of the first set of conditions. The processing entity 108 may update the account database 115 to reflect the account activation and the acceptance of the first set of conditions. Account activation may also occur using other conventionally known methods, such as, e.g., calling a phone number to activate the account or clicking on an account activation link on a website associated with the convertible prepaid account.

When the account holder 110 makes a purchase at one or more merchants 122 using the convertible prepaid account, the merchant 122 may provide usage information, including an amount to be debited from the convertible prepaid account balance, to the payment network 120 affiliated with the convertible prepaid account. The payment network 120 may arrange to have a cash value of each purchase made with the convertible prepaid account deducted from the account balance. For example, in one embodiment, the payment network 120 may notify the processing entity 108 of each account usage and may instruct the processing entity 108 to deduct the purchase amount from the account balance stored in the account database 115. The payment network 120 may also arrange for the transfer of money to the merchant 122 from the issuing bank 114 in the case of a purchase, and vice versa in the case of a credit or load (as explained in more detail below). In one embodiment, the payment network 120 determines which issuing bank and processing entity is affiliated with the convertible prepaid account based on the account number. For example, the payment network 120 may use a look-up table that includes the account numbers of each affiliated prepaid account and the issuing bank and processing entity associated with each account.

The facilitator 102 may further arrange to present the account holder 110 with an offer to convert the non-user-funded prepaid account to a user-fundable prepaid account. In one embodiment, the offer may be provided to the account holder 110 along with the account transaction mechanism 116 and/or the account information. For example, in the example of a physical prepaid card 116 that is mailed to the account holder 110, the account holder 110 may also receive promotional materials that explain to the account holder 110 the availability of an option to convert the present prepaid account into a more versatile, user-fundable prepaid account. Alternatively, the facilitator 102 may arrange for the conversion offer to be provided electronically (e.g., via an email, a text message, or on a website). For example, upon creation of a virtual prepaid card 116, the facilitator 102 may send an email to the account holder 110 informing her that the virtual prepaid card is ready for use, and in the same email, or in a subsequent email, the facilitator 102 may include information regarding the offer to convert the virtual card 116 to a user-fundable virtual card. In yet another example, the facilitator 102 may arrange for the conversion offer to be provided via telephone (e.g., by telemarketers affiliated with or contracted by the facilitator 102) or via a virtual agent (e.g., a virtual telemarketer controlled by the facilitator 102). In some embodiments, the facilitator 102 may contract a third party marketing entity to handle electronic and/or paper mailings of the promotional materials, the account information, and/or the offer to convert.

According to some aspects, the offer to convert the non-user-funded account to a user-fundable account may be accepted in writing, online, and/or over the phone. For example, the promotional materials may include a registration form (e.g., similar to those provided with credit card offers) that the account holder 110 can fill out and mail to the facilitator 102 in order to accept the offer to convert. As another example, the facilitator 102 may provide the registration form on a website associated with the convertible prepaid account. Receipt of the registration form by the facilitator 102 may constitute acceptance of the offer to convert.

According to a preferred embodiment, account conversion is contingent on completing the step of verifying identity information provided by the account holder 110, as required by current laws pertaining to open system prepaid cards (e.g., the USA Patriot Act of 2001). The account holder 110 may be requested to provide identity validation information in, for example, the registration form. According to one embodiment, this validation information may include a social security number, a date of birth, and any other information required by law to verify the identity of the account holder 110.

Upon receiving the validation information from the account holder 110, the facilitator 102 may provide the validation information to an identity validation provider 124. The identity validation provider 124 may process the validation information and determine whether or not the identity of the account holder 110 may be confirmed and/or verified using, for example, a conventionally known consumer identification process. Due to the current law, the non-user-funded prepaid account cannot be converted into a user-fundable prepaid account if the identity validation provider 124 cannot verify the identity of the account holder 110. If the identity validation provider 124 is able to verify the identity of the account holder 110 based on the received validation information, the identity validation provider 124 will notify the facilitator 102 of the verification.

Upon receiving such notification, the facilitator 102 may instruct the processing entity 108 to convert the account into a user-fundable prepaid account, which includes the step of changing the product id associated with the account. For example, the processing entity 108 may replace the first product id, which is associated with the non-user-funded prepaid account, with the second product id, which is associated with a user-fundable prepaid account, in the account database 115. This change in product id may be utilized as a process to automatically change the parameters, restrictions, conditions, and other features associated with the newly converted account. For example, the user-fundable account may subsequently be associated with the second set of conditions, which include more demanding terms and conditions between the account holder 110 and the issuing bank 114. The account holder 110 may be notified of this change in conditions when registering the account as a user-fundable prepaid account (e.g., in the promotional materials).

Once the conversion of the convertible prepaid account is complete, the account holder 110 may begin to load money onto, or add to the balance of, the account. According to one aspect, the account holder 110 may add money to the account through one or more load agents 126 using conventional means. The load agents 126 may include, for example, electronic money transfer networks, such as, e.g., Western Union, MoneyGram, Green Dot MoneyPak, PayPal, Automated Clearing House (ACH), etc. The load agents 126 may be accessed online, via telephone, and/or at kiosks in retail locations (e.g., Walmart). The load agents 126 may also include, for example, an employer of the account holder 110, wherein the account holder 110 wishes to have a payroll amount directly deposited into the convertible prepaid account. The load agents 126 may further include, for example, government agencies, wherein the account holder 110 wishes to have government benefits or tax refunds directly deposited into the account.

In some embodiments, the load agents 126 may provide usage information, including a cash value that was added to the account, to the payment network 120. The payment network 120 may provide the usage information to the processing entity 108 for storage in the account database 115 and for updating the account balance of the convertible prepaid account. In another embodiment, the load agents 126 may provide the usage information directly to the processing entity 108. In either case, the processing entity 108 may notify the facilitator 102 once an account balance has been updated and/or once usage information has been received. In order to add or load money to the convertible prepaid account, the payment network 120 may instruct the load agent 126 to transfer the money received from the account holder 110 to the issuing bank 114 for deposit into the deposit account 112. Upon receiving the money, the issuing bank 114 may notify the processing entity 108 of the money transfer, and the processing entity 108 may in turn update the account database 115 to reflect the change in the account balance. Other conventionally known means for transferring funds from a load agent to an issuing bank may also be used.

Referring now to FIGS. 1, 2, and 6, the account conversion application 104 may reside on a server or a computer, such as the computing device 200 shown in FIG. 2, and/or may reside on various interface devices, for example, by being downloaded through the Internet or other network, or copied into memory on those interface devices through transport on a computer readable medium. In a preferred embodiment, the account holder 110 may interact with the account conversion application 104 through an account holder interface, the facilitator 102 may interact with the account conversion application 104 through a facilitator interface, and the account conversion application 104 may be configured to provide notifications and/or information to at least the processing entity 108 based on information received from the facilitator 102 and/or the account holder 110. In other embodiments, other components of the system 100 may also interact with or receive notifications from the account conversion application 104 through appropriate interfaces (e.g., the funding entity 106, the processing entity 108, and/or the identity validation provider 124).

In one embodiment, one or more of the above interfaces can be software programs designed to operate on respective computing or interface devices and tailored to interact and exchange data with the account conversion application 104. These software programs can include mobile applications that can be executed on a smart phone, mobile device, and the like. In some embodiments, one or more of the interfaces can reside only on a server associated with the facilitator 102 and can be standard web browser software programs, such as Internet Explorer, Firefox, Chrome, or Safari. In such embodiments, the facilitator 102 and the account holder 110, for example, may use the browser interface to interact with the account conversion application 104. Further, according to these embodiments, the account conversion application 104 can be implemented as a web page hosted by a server or other computing device associated with the facilitator 102 (e.g., the computing device 200).

FIG. 2 is a block diagram of an exemplary computing device 200 that houses executable software used to facilitate the system 100. One or more instances of the computing device 200 may be utilized by, or to implement, any, some, or all of the components in the system 100. Thus, the computing device 200 may be representative of any computer utilized within, or to implement, the system 100, and includes any type of computing device, including one or more special or general purpose digital computer(s), such as a mainframe computer, a personal computer (desktop, laptop, tablet-type, or otherwise), a personal digital assistant, a smartphone, or other handheld or mobile computing device. In one embodiment, the computing device 200 may be configured to exchange information with one or more components of the system 100 in accordance with the principles disclosed herein. In some embodiments, the facilitator 102 may include, operate, own, control, or otherwise be affiliated with a computing device, such as the exemplary computing device 200.

As shown in FIG. 2, computing device 200 includes processing hardware 202. The processing hardware 202 can include a memory 204 (e.g., random access memory (RAM, such as DRAM, SRAM, SDRAM, etc.) and/or nonvolatile memory elements (e.g., ROM, hard drive, tape, CDROM, etc.)), a central processing unit (CPU) 206 (e.g., a microprocessor, and the like; also referred to herein as “the computer processor 206”), and an I/O portion 208. The CPU portion 206 can be any computer-processing unit from a singular microchip to extensive microchip configuration. Moreover, the memory portion 204 may incorporate electronic, magnetic, optical, and/or other types of storage media, and can have a distributed architecture where various components are situated remotely from one another, but are still accessed by the microprocessor portion 206. The computing device 200 can further include an interactive hardware portion 210 (e.g., a keyboard, a mouse, and the like). The interactive hardware portion 210 is coupled to the I/O portion 208 such that a command or other input entered or provided by a user through the interactive hardware portion 210 will be forwarded to the I/O portion 208, to the microprocessor portion 206, and then to the memory portion 204.

Memory portion 204 may include a computer readable medium for implementing all or portions of the system 100, and for implementing particular system transactions. Memory portion 204 may also be utilized to implement at least part of one or more databases utilized by the system 100. Computing device 200 also includes executable software, some of which may or may not be unique to the system 100. When the computing device 200 is in operation, the CPU portion 206 can be configured to execute software stored within the memory 204, to communicate data to and from the memory 204, and to generally control operations of the computer 200 pursuant to the software. In one embodiment, the memory 204 stores one or more executable computer programs, such as, e.g., the account conversion application 104, which may be executed by the computer processor 206 to carry out the principles disclosed herein. The executable program can be implemented in software, firmware, hardware, or a combination thereof.

According to some aspects, the memory 204 also stores at least part of a database 212. In one embodiment, the memory 204 stores the database 212 and the account conversion application 104. In another embodiment, the database 212 and the account conversion application 104 are stored in different memories on different computers or servers. The database 212 may include information related to the account conversion application 104 and/or any convertible prepaid accounts that are managed and arranged by the facilitator 102. To that extent, the account conversion application 104 may be in communication with the database 212 and may extract information from or store information in the database 212, as needed.

In one embodiment, the database 212 may include all or portions of the account database 115 shown in FIG. 1. In one embodiment, all or portions of the database 212 and/or the account database 115 may be stored on a cloud server and may be accessible by both the facilitator 102 and the processing entity 108 to carry out account creation, conversion, and/or management, as described herein. The database 212 may include the request information, account information, validation information, usage information, and/or activation information for each convertible prepaid account managed by the facilitator 102, as well as other information related to the accounts.

When the account conversion application 104 is implemented in software, it can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The account conversion application 104 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. In some embodiments, the computer readable medium is non-transitory. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium also may comprise paper or another suitable medium upon which the program is printed, as the program can be electronically captured, via, for instance, optical scanning of the paper or other medium, then compiled, interpreted or otherwise processed in a suitable manner if necessary, and then stored in a computer memory.

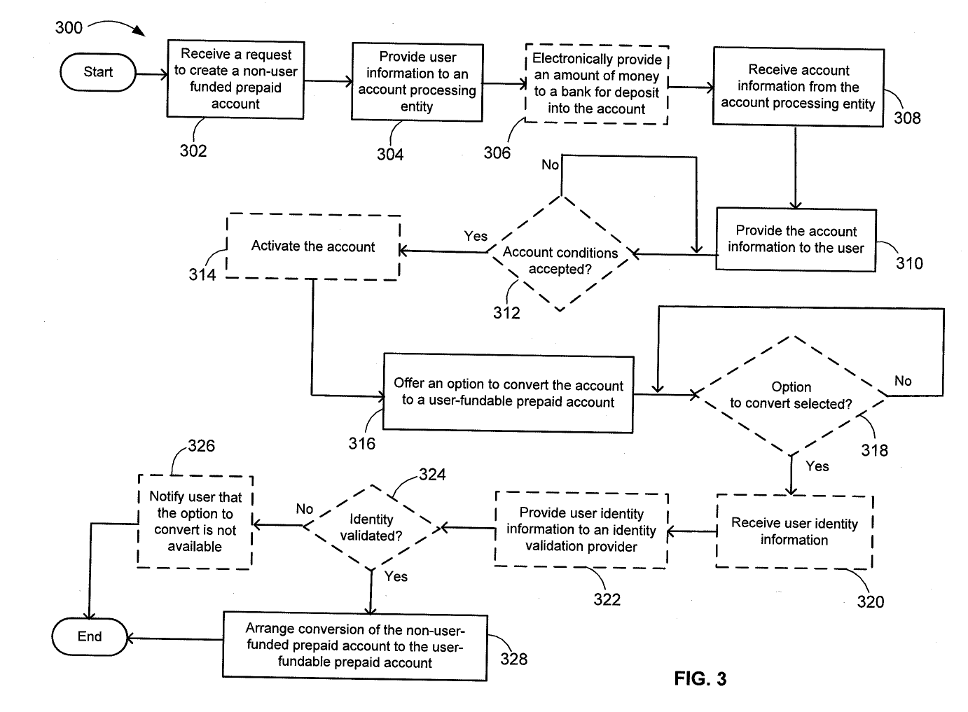

Referring now to FIG. 3, shown is a flowchart of an exemplary method 300 for managing and promoting a prepaid account system using the system 100. In some embodiments, all or portions of the method 300 may be implemented in software as an executable program and executed by one or more computers (such as, e.g., the exemplary computing device 200). For example, all or portions of the software for implementing the method 300 may be stored in a memory (such as, e.g., memory portion 204) and executed by a computer processor (such as, e.g., computer processor 206) of a computing device associated with the system 100. According to one embodiment, the executable program can include the account conversion application 104. According to one aspect, a prepaid account facilitator (such as, e.g., the facilitator 102) may implement all or portions of the method 300 using a computer associated with the facilitator.

The method 300 may begin at step 302, wherein a request to create a new convertible prepaid account, or more specifically, the initial non-user-funded prepaid account, for a user is received. According to one embodiment, the non-user-funded prepaid account may be a non-user-reloadable prepaid account and/or other type of account in which the account holder, or user, cannot add funds into the account. According to one embodiment, the user-fundable prepaid account may be a user-reloadable prepaid account and/or other type of account in which the user can load funds onto the account. In some embodiments, the non-user-funded prepaid account may be reloaded by the funding entity but not by the user.

The request to create a new account may include information about the user and an amount of money to be deposited into the new account. According to one embodiment, the user information may include at least a name and an address of the user/account holder, and any other information required by current regulations related to prepaid accounts. The request may be received by an account provider (such as, e.g., the facilitator 102) from a funding entity (such as, e.g., the funding entity 106) that is funding the amount of money included in the request. According to one aspect, the funding entity may request the prepaid account to provide certain funds to the user as an alternative to cash, check, or other payment means.

At step 304, the user information included in the request is provided to a prepaid account processing entity (such as, e.g., the processing entity 108) to establish the convertible prepaid account, or more specifically, the non-user-funded prepaid account. The convertible prepaid account may be created using techniques described herein and/or conventionally known account creation methods. According to some embodiments, the method 300 further includes a step 306, wherein the amount of money included in the request is provided to a bank associated with the non-user-funded prepaid account (such as, e.g., the issuing bank 114) for deposit of the money into, for example, a bank account (such as, e.g., the deposit account 112) at the bank.

The method 300 may further include a step 308, wherein account information for the newly created convertible prepaid account is received from the account processing entity. The account information may include at least an account number associated with the account. From step 308, the method 300 may continue to step 310, wherein the account information is provided to the user. According to some embodiments, providing the account information to the user includes providing an account transaction mechanism (e.g., account transaction mechanism 116) to the account holder, the account transaction mechanism being associated with the convertible prepaid account and the convertible prepaid account being associated with both the initial non-user-funded prepaid account and the ultimate user-fundable prepaid account. As an example, if the account transaction mechanism is a physical prepaid card, the account information may be provided to the user by mailing the physical prepaid card to the user, and the physical card may have the user's name and/or account number printed thereon. As another example, if the account transaction mechanism is a virtual prepaid card, the account information may be provided to the user by emailing, displaying online (e.g., on a website), or otherwise providing electronic access to the virtual prepaid card to the user, and the virtual card may include the user's name and/or account number. In yet another example, if the account transaction mechanism is a mobile payment device, the account information may be provided to the user by offering an option to download the mobile payment device onto an electronic device of the user.

At step 312, the method 300 may further include determining whether an indication of acceptance of conditions associated with the account has been received. In some embodiments, the convertible prepaid account may be associated with certain terms and conditions related to bank regulations and other legal requirements that the user must agree to before using the account, as is conventional. The exact conditions associated with each account may vary depending on a category to which the account belongs and/or a product id associated with the account. For example, the non-user-funded prepaid account may be associated with a first product id, which may be associated with a first set of conditions. In a preferred embodiment, the non-user-funded account is rendered active upon receipt of confirmation from the user of agreement to such conditions (e.g., “an acceptance notice”), whether passively (e.g., using the account to make purchase) or actively (e.g., calling a designated phone number). According to some aspects, upon receipt of the acceptance notice, both the non-user-funded account and the account transaction mechanism associated therewith are activated. As another example, the user-fundable prepaid account may be associated with a second product id, which may be associated with a second set of conditions. As described herein, the first set of conditions may be different from the second set of conditions, as the account features associated with the first product id are different from the account features associated with the second product id. For example, the second set of conditions may require adherence to FDIC and Regulation E requirements, while the first set of conditions may not, as described herein. According to some aspects, the first product id may be associated with the account transaction mechanism upon receipt of the acceptance notice, and the second product id may be associated with the account transaction mechanism upon receipt of an identity verification notice, as described below.

If the determination at step 312 is negative (e.g., no notice of acceptance), the method 300 waits until the user accepts the conditions and the computer processor receives an indication of this acceptance. If the determination at step 312 is positive (e.g., an acceptance notice is received), the method 300 continues to step 314, wherein the non-user-funded account is activated. The user may indicate acceptance of these conditions using direct or indirect methods. In one embodiment, the user may indicate acceptance of the first set of conditions by using the convertible prepaid account to make a purchase at a merchant location. In such an embodiment, receiving an indication of acceptance of account conditions may include receiving, at the computer processor, notification of that the non-user-funded account has been used to make a purchase. Said notification may have been received from, for example, the merchant where the purchase was made, the bank that transferred the purchase amount to the merchant, or other entity associated with the purchase. In another embodiment, the user may indicate acceptance of the first set of conditions by selecting an option to activate the non-user-funded account on a website, over the phone, and/or by mailing in an activation form.

At step 316, the method 300 includes offering the user an option to convert the non-user-funded prepaid account to a user-fundable prepaid account. As described herein, the offer to convert may be provided in paper, electronically, and/or over the phone. In one example, the facilitator 102 may arrange to have electronic and/or paper brochures sent to the user, the brochures including the offer to convert. In another example, the facilitator 102 may arrange to have a third party entity provide the marketing brochures that contain the offer to convert.

In some embodiments, the method 300 includes step 318, which includes determining whether a selection of the option to convert has been received. If the determination at step 318 is negative, the method 300 continues to check for a positive determination (e.g., waits for acceptance of the offer to convert). If the determination is positive, the method 300 continues to step 320. The user may select or accept the offer to convert using the same communication channel (e.g., mail, email, phone) through which the offer was presented and/or using any other acceptable method, as determined by the facilitator 102. In a preferred embodiment, information provided to the user establishes an agreement whereby the user's acceptance of the offer to convert to the user-fundable prepaid account is considered an automatic acceptance of the second set of conditions that are associated with the user-fundable prepaid account.

In some embodiments, the method 300 includes step 320, wherein information about a user identity is received with the selection of the option to convert. For example, receiving a selection of the option to convert may be associated with receiving information about the user identity. According to one aspect, receiving a selection of the option to convert may include receiving registration information from the user in a registration form. For example, the user may select the option to convert by filling out a registration form that is provided with the offer to convert. As described above, the registration form may require user identity information, such as a social security number, a date of birth, and/or any other identity verification information required by current regulations related to prepaid accounts. The method 300 may also include step 322, wherein the received user identity information is provided to an identity validation provider (such as, e.g., identity validation provider 124) for verification of the identity information. The method 300 may further include step 324, which includes determining whether the identity validation provider has verified the validity of the user identity information. According to some aspects, the step of determining the validity of the user identity occurs after the step of receiving a selection of the option to convert.

If the determination at step 324 is negative (e.g., the information is not valid), the method 300 may continue to step 326, where a notification is sent to the user stating that the identity information could not be verified and therefore, the option to convert is not available. If the determination at step 324 is positive (e.g., the information is valid), the method 300 may continue to step 328, which includes arranging a conversion of the non-user-funded prepaid account to the user-fundable prepaid account. In one embodiment, arranging this conversion includes instructing the account processing entity to change the product id associated with the account. That is, upon receiving a selection of the option to convert and upon verifying the user-provided identity information, the computer processor may send an instruction to change the first product id, which defines the non-user-funded prepaid account, to the second product id, which defines the user-fundable prepaid account. In an embodiment of this system, the account transaction mechanism may remain active as the account is converted from a non-user-funded account to a user-funded account. The method 300 may end once the convertible prepaid account is converted to a user-fundable prepaid account.

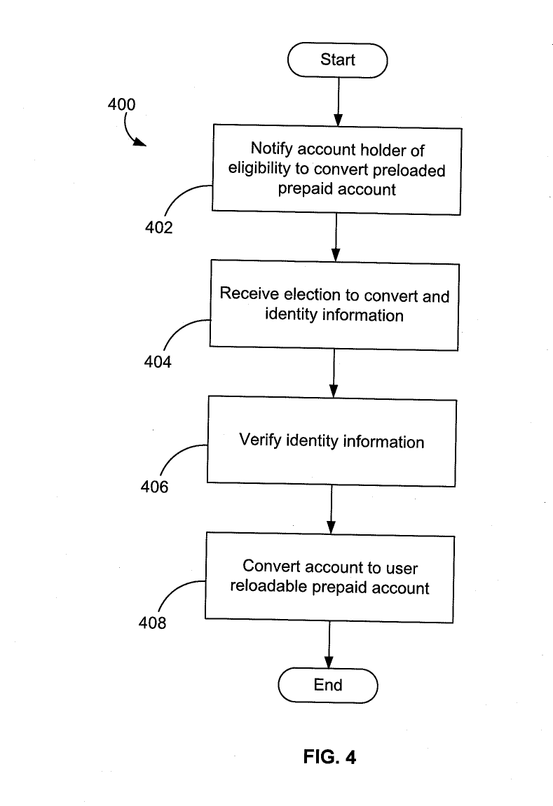

Referring now to FIG. 4, shown is a flowchart of an exemplary method 400 for marketing a user reloadable prepaid account using the system 100. In some embodiments, all or portions of the method 400 may be implemented in software as an executable program and executed by one or more computers (such as, e.g., the exemplary computing device 200). For example, all or portions of the software for implementing the method 400 may be stored in a memory (such as, e.g., memory portion 204) and may be executed by a computer processor (such as, e.g., computer processor 206) of a computing device associated with the system 100. According to one embodiment, the executable program can include the account conversion application 104. According to one aspect, a prepaid account facilitator (such as, e.g., the facilitator 102) may implement all or portions of the method 400 using a computer associated with the facilitator.

The method 400 may begin at step 402, wherein an account holder of a non-user-funded prepaid account (such as, e.g., account holder 110) is notified of an eligibility to convert the account to a user-fundable prepaid account. The method 400 continues to step 404 where information is received from the account holder regarding an election by the account holder to convert the account and an identity of the account holder. The identity information may include, for example, a social security number and/or a date of birth of the account holder. In some embodiments, the election to convert may be incorporated into the provision of the identity information. For example, the receipt of identity information may be considered to be an automatic election to convert. As another example, the election to convert may be indicated on the same form (paper or electronic) that is used to provide the identity information.

From step 404, the method 400 continues to step 406, where the identity information of the account holder is verified. In one embodiment, the identity information may be verified by consulting a third party, such as, e.g., the identity validation provider 124. The method 400 continues to step 408 upon receiving verification of the identity information. Also at step 408, the non-user-fundable prepaid account is converted into the user-fundable prepaid account by changing a first product id associated with the non-user-funded prepaid account to a second product id that defines the user-fundable prepaid account. In some embodiments, the method 400 may end upon completing the account conversion.

According to some embodiments, the method 400 further includes establishing the non-user-funded prepaid account and loading an amount of non-user-provided funds into the non-user-funded prepaid account. In one embodiment, the step 402 of notifying the account holder of eligibility to convert is provided in association with an offer to active the non-user-funded prepaid account after establishing the account. According to another embodiment, the method 400 further includes issuing an account transaction mechanism (such as, e.g., the account transaction mechanism 116) to the account holder after establishing the non-user-funded prepaid account. The account transaction mechanism is initially associated with the non-user-funded prepaid account and is eventually associated with the user-fundable prepaid account after the account conversion.

In still another embodiment, the method 400 further includes activating the account transaction mechanism upon receiving required notification from the account holder. The account transaction mechanism may remain activated during the conversion of the non-user-funded prepaid account to a user-fundable prepaid account. The required notification may include acceptance of a first set of conditions that are associated with the non-user-funded prepaid account. For example, acceptance may be automatically provided by using the non-user-funded prepaid account to make a purchase.

Referring now to FIG. 5, shown is an exemplary flow of funds or money between various components of the system 100, including the funding entity 106, the payment network 120, and the load agent(s) 126. However, the present disclosure is not limited to the exact funds flow illustrated in FIG. 5. Any conventional or known method for transferring money into a prepaid account may be used in accordance with the principles disclosed herein.

As shown in FIG. 5, a plurality of bank accounts may be utilized to hold all or a portion of the funds that may be received in connection with the convertible prepaid account at various stages of the account's existence, as described herein. According to some aspects, one or more of the plurality of bank accounts may be stored in the issuing bank 114 shown in FIGS. 1 and 6 and discussed above. In instances where funds have been provided by the funding entity 106 to initiate creation of a convertible prepaid account, the funding entity may deposit the funds into an operations account 504 that is owned by the facilitator 102. As shown in FIG. 5, from the facilitator's operations account 502, the funds are transferred to a funding account 504 that receives all funds that are to be loaded onto the convertible prepaid account. According to one embodiment, the funding account 504 may be the deposit account 112 at the issuing bank 114 shown in FIG. 1. Other entities may also deposit money into the funding account 504 for the purpose of loading money onto the convertible prepaid account. For example, the funding account 504 may also receive funds from one or more load agents 126, including, for example, Money Gram, Western Union, Visa Ready Link, Mazooma, PayPal, the Federal government (e.g., the Internal Revenue System,), Direct Deposit, or any other entity or method for loading money onto a prepaid account, as is conventional.

The funding account 504 may also receive money from the funding entity 106 through a batch account creation method. According to this method, the funding entity 106 creates a file that includes a list of all new convertible prepaid accounts to be created by the facilitator 102 and the amount of money to be loaded into each account. The funding entity 106 sends this file to the facilitator 102, which sends the file to the processing entity 108 for processing the file information and for setting up the batch of accounts. Upon setting up the accounts, the processing entity 108 may work with the bank that controls the funding account 504 to load the appropriate funds into each account. In some instances, the processing entity 108 may do so before the funds have actually reached the funding account 504. According to one aspect, this may be possible when, for example, the funding entity 106 regularly sends batch files to the facilitator 102 and regularly funds the funding account 504 and/or the operations account 502 as needed.

After collecting money in the funding account 504, the processing entity 108 may “push” or allocate funds into an activity account 506 for each convertible prepaid account. Once loaded into the activity account 506, the funds become available for use by the account holder 110. Whenever the account holder 110 spends the funds in the account 506, for example, at the merchant 122, the amount of money spent at the customer spending 508 is transferred to the payment network 120 that is associated with the convertible prepaid account. The payment network 120 may then provide the amount of money spent by the account holder 110 to the merchant 122.

In some embodiments, the convertible prepaid account may be associated with fees, such as cardholder fees, bank fees, and/or usage fees charged by the facilitator 102. These fees may be withdrawn from the associated activity account 506. According to one aspect, such fees may not be charged until the account is converted to a user-fundable prepaid account. In other embodiments, the fees may be charged before and after the conversion.

According to an embodiment in which the account conversion application 104 is implemented in software and stored on a non-transitory computer readable medium, the computer readable medium may comprise instructions for execution on a computer processor for performing steps for managing and promoting a prepaid account in accordance with the teachings disclosed herein. These steps may include receiving a request to create a non-user-funded prepaid account for a user. Referring back to FIGS. 1 and 6, the request may be received by the account conversion application 104 from the funding entity 106 and may include information about the user and an amount of money to be deposited into the non-user-funded prepaid account. The steps may further include providing the user information to the account processing entity 108 to establish the non-user-funded prepaid account. The steps may also include receiving account information for the non-user-funded prepaid account from the account processing entity 108 and providing the account information to the account holder 110. The steps may additionally include offering the account holder 110 an option to convert the non-user-funded prepaid account to a user-fundable prepaid account. The steps may also include in response to receiving a selection of the option to convert from the account holder 110, arranging a conversion of the non-user-funded prepaid account to the user-fundable prepaid account. In one embodiment, at least one of the non-user-funded prepaid account or the user-fundable prepaid account may be associated with an account transaction mechanism.

Any process descriptions or blocks in figures should be understood as representing modules, segments, or portions of code which include one or more executable instructions for implementing specific logical functions or steps in the process, and alternate implementations are included within the scope of the embodiments described herein. For example, functions may be executed out of order from that shown or discussed, including substantially concurrently or in reverse order, depending on the functionality involved, as would be understood by those having ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1-33. (canceled)

34. A method of marketing a user-fundable prepaid account, the method comprising:
notifying, using a computer processor, an account holder of a non-user-funded prepaid account of an eligibility to convert the non-user-funded prepaid account to a user-fundable prepaid account;
receiving, via the computer processor, information from the account holder regarding an election by the account holder to convert the account and an identity of the account holder;
verifying, using the computer processor, the identity information of the account holder; and
upon receiving verification of the identity information, converting, using the computer processor, the non-user-funded prepaid account to the user-fundable prepaid account by changing a first product id associated with the non-user-funded prepaid account to a second product id that defines the user-fundable prepaid account.

35. The method of claim 34, further comprising:
establishing the non-user-funded prepaid account; and
loading an amount of non-user-provided funds into the non-user-funded prepaid account.

36. The method of claim 34, further comprising: issuing an account transaction mechanism to the account holder, the account transaction mechanism being initially associated with the non-user-funded prepaid account and being associated with the user-fundable prepaid account after the account conversion.

37. The method of claim 36, further comprising: activating the account transaction mechanism upon receiving required notification from the account holder.

38. The method of claim 37, wherein the account transaction mechanism remains activated during the account conversion.

39. The method of claim 34, wherein the notifying the account holder of eligibility to convert is provided in association with an offer to activate the non-user-funded prepaid account.

40-41. (canceled)

42. The method of claim 36, wherein the account transaction mechanism is a physical card.

43. The method of claim 36, wherein the account transaction mechanism is a virtual representation of the prepaid account.

44. The method of claim 34, wherein changing the first product id to the second product id includes instructing an account processing entity, via the computer processor, to implement the change.

45. The method of claim 34, wherein verifying the identity information includes:
providing, via the computer processor, the identity information to an identity validation provider; and
receiving, via the computer processor, validation of the identity information from the identity validation provider.

46. The method of claim 34, wherein the identity information includes identity verification information required by current regulations related to prepaid accounts.
